(19) United States
(12) Patent Application Publication
(10) Pub. No.: US 2001/0016864 A1
(43) Pub. Date: Aug. 23, 2001

(54) Computing unit for signal processing

(76) Inventor: Carsten Noeske, Glottertal (DE)

Correspondence Address: Samuels, Gauthier & Stevens LLP, Suite 3300, 225 Franklin Street, Boston, MA, 02110, US

(21) Appl. No.: 09/773,164

(22) Filed: Jan. 31, 2001

(30) Foreign Application Priority Data
Jan. 31, 2000 (DE) 100 04 012.8
Feb. 29, 2000 (DE) 100 09 451.1-53

(51) Int. Cl. G06F 7/52

(52) U.S. Cl. 708/620

(57) ABSTRACT

A computer unit for a first (z) and a second (k, k*) number comprising at least one place shifting device (3, 4), whose shift position is controlled by an associated shift instruction (s1, s2) in dependence on the second number (k, k*), and to whose position inputs are conducted the value-ordered places of the first number (z), which generally is a binary coded dual number. The input or output of each place shifting device (s1, s2) has associated with it a sign inverter (5, 6), which is controlled by an associated sign instruction (n1, n2), in dependence on the second number (k, k*), which generally is a binary coded dual number using the canonical form, and on the output side, each place of the place shifting device (3, 4) is connected respectively to a place input of a four-place adder (7).

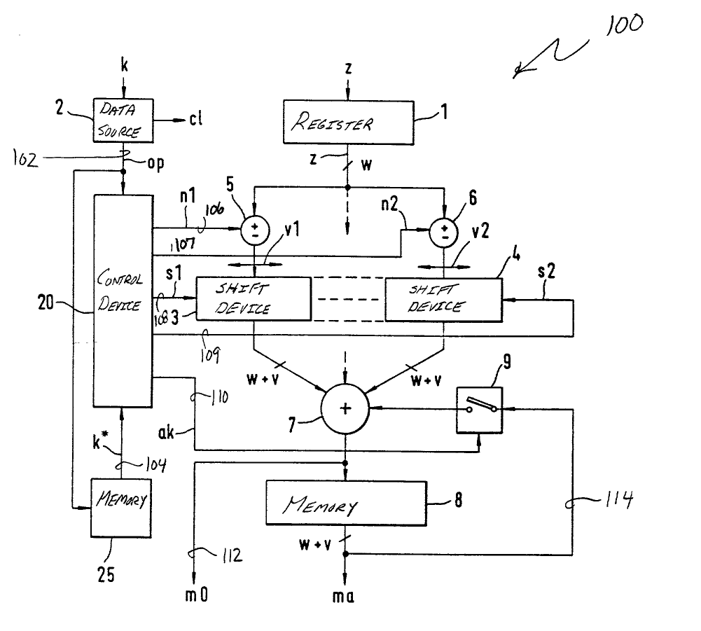

### BACKGROUND OF THE INVENTION

The invention relates to a computing unit for a programmable logic unit, such as a processor or microcontroller, and in particular to a computing unit that multiplies signal values by shifting data bits of a multiplicant.

Digital signal processing often requires multiplications with subsequent summation of the resultant products, for example in the implementation of various digital filters. Digitized signal values of successive sampling times are often multiplied by different factors, and the individual products are added. The resulting sum may be further processed. The different factors by which the digitized signal values are multiplied correspond to coefficients given by the particular filter properties. So that the filters operate in real time even at high signal frequencies, a much higher clock frequency or time-staggered parallel processing (e.g., a pipeline process) must be chosen for the usual signal multipliers. Alternatively, much more complex hardware is included that can perform a real multiplication within a few clock cycles or even within a single clock cycle.

Therefore, there is a need for a computing unit that is configured and arranged to perform relatively fast multiplication operations.

### SUMMARY OF THE INVENTION

Briefly, according to an aspect of the present invention, a computing device located on a monolithic integrated circuit computes the product of a digitized multiplier signal value and a digitized multiplicant signal value. The computing device includes an input interface that receives the multiplicant and provides a received multiplicant indicative thereof. A first place shifting device includes a first logical assignment circuit to shift data bits of the received multiplicant in response to a first shift command signal, and provides a first shifted signal indicative thereof. A second place shifting device includes a second logical assignment circuit to shift data bits of the received multiplicant in response to a second shift command signal, and provides a second shifted signal indicative thereof. The first and second shifted signals are summed to provide a summed signal value indicative of the product of the multiplier and the multiplicant. A control device receives a signal indicative of the multiplier value, and generates the first and second shift command signals indicative of said multiplier value.

The present invention is based upon an observation that under certain preconditions the computing unit can be simplified for its intended application as a multiplier, especially for example, in the implementation of digital filters. If the only numbers permitted for the filter coefficients are those that can be presented relatively simply as a simple power of two or as a simple sum and/or difference of powers of two, the hardware structure of the multiplier can be greatly simplified. Simple representations in the form of powers of two are, for example, binary coded dual numbers which have only one, two, or three binary places of arbitrary order. The multiplication can then be performed by only one, two or three place shifts, or by place assignment operations with one, two or three place shifting devices (e.g., barrel shift registers), and subsequent place-correct addition of the place-shifted bits. It is not even necessary for the shift process that all the intermediate places are accessible. For example, if the powers of two 2³ and 2⁵ never occur in the choice of numbers, then the shift positions are reduced by three and five binary places. Of course, the discussion of the invention in terms of binary numbers does not exclude the use of other number systems, for example on a ternary basis, the invention includes arbitrary number systems.

The computing unit operates with both positive and negative numerical and coefficient values that correspond to the canonical representation of binary coded dual numbers. This requires negation of the numerical value before the addition of the shift results. The negation can take place before or after the barrel shift register. The place shift can be either in the direction of higher values or in the direction of lower values. A shift direction toward lower values corresponds to a division by a power of two or to multiplication by a reciprocal power of two. Since the narrow shift register as a rule needs to realize only a few shift positions, logical assignment circuits are advantageously used instead of the usual shift registers. Such circuits link the positions of the data word being multiplied with the new place positions, via a switching network. The switching instructions that control the various assignment switches are formed as control signals or instructions in dependence on a control word. This technique is faster than using a standard shift register, which must traverse all the intermediate positions. Another advantage of the logical assignment circuits is the relatively small area needed for monolithic integration, since the memories needed by the shift register for the intermediate positions are obviated.

These and other objects, features and advantages of the present invention will become more apparent in light of the following detailed description of preferred embodiments thereof, as illustrated in the accompanying drawings.

### BRIEF DESCRIPTION OF THE DRAWING

The FIGURE is a block diagram illustration of a computing unit.

### DETAILED DESCRIPTION OF THE INVENTION

A computing device 100 includes a register 1 that receives a digitized multiplicant value z. The computing device 100 also receives a multiplier value k and computes the product of the multiplicant and multiplier values. The multiplicant value z is multiplied by the multiplier value k from either a data source 2 or a memory device 25. The second data source 2 is for example, part of a monolithically integrated processor. The second data source 2, or a clock generator (not shown) provides a system cycle cl. The memory device 25 receives data from the data source 2, and provides data to a control device 20. The previously read-in or stored multiplier values k can be stored in the memory device 25 in any processed form k*, and can be retrieved from the data source 2 or the control device 20 by a control word. Unlike the multiplicant signal values, which are numerically finely divided and can assume any arbitrary value within the specified range and resolution, the multiplier values k are permanently specified numerical values with a very small number of binary places. The multiplier values k represent a selection of binary coded dual numbers, preferably in canonical form.

The computations implemented in the computer device 100, for example to provide a digital filter, are controlled by control words op on a line(s) 102 from the second source 2. The control device 20 receives the control word on the line 102, the stored multiplier value k* on a line 104 and generates within a single clock cycle the parallel required control signals/instructions n1, n2, s1, s2, ak on lines 106-110 respectively, for the individual function units. Specifically, the control signals/instructions on the lines 106 control the computing device 100 operation of multiplying the multiplicant value z and the multiplier value k to provide a signal value m0 on a line 112 indicative of the resultant product, also within this single clock cycle. To perform the multiplication the computing unit 100 includes first and second place shifting devices 3-4 respectively, sign inverters 5-6, and a four-place adder 7 with a switchable summation path. If a finer resolution is required, additional place shifting devices must be provided, and these are indicated in the FIGURE by dashed lines.

In each data path an associated one of the first and second sign inverters 5-6 is located prior to its associated one of the first and second place shifting devices 3-4. The common adder 7 is configured and arranged to add the individual outputs of the place shifting devices 3, 4 and provide a summed signal value m0 on a line 112 indicative thereof.

The given inventory and format of the multiplier values k, k* determine how many shift positions the place shifting devices 3-4 require. Furthermore, they determine the associated maximum shift distance v1, v2 and the shift direction. The maximum shift distance v for all the place shifting devices 3-4, and the maximum number w of places of the multiplicant value z, determine the number w+v of places of the adder 7 and of a summation memory 8, from whose output a summed multiplication value ma is provided on a line 114. The summation memory output on the line 114 is fed back to the adder 7 through a switch 9 that is controlled (i.e., opened and closed) by the signal ak on the line 110 from the control device 20.

The multiplicant value z may be negated by the sign instructions nil, n2 on the lines 106-107 respectively, for those multiplier values k, k* which, in the canonical representation contain a binary place with a negative value. For example, consider the multiplier value k=28 that can be represented in the canonical form k=(2⁵−2²). In this example the value provided to the second place shifting device 4 is inverted and shifted two places in the direction of the most significant bit (MSB), while the negation device 5 does not negate its received signal value which is shifted five places in the direction of the MSB in the first shift device 3. The control information is delivered by the cyclically furnished control word op on the line 102, as parallel control signals or instructions n1, n2, s1, s2 on the lines 106-109, respectively.

If a multiplier value k from the available number inventory does not require all the place shifting devices (e.g., because the multiplier value k corresponds to a plain power of 2ⁿ) then only a single place shifting device is needed since the others do not make any contribution. This nulling or null position is coded in the shift instruction s1, s2 on the lines 108-109 respectively by a numerical value or a bit sequence. For example, if the shift instruction s1 or s2 for a place shifting device 3 or 4 contains two binary places, then either four different shift positions can be programmed or three different shift positions and one null position, for example the four shift positions by 5, 3, 0, or −2 places, or the three shift positions by 5, 3, or 1 place, but then also the null position.

The adder 7 can have very different structures, for example a tree structure after Wallace, so as to be able to form the summed value ma on the line 114 within a single clock cycle. Less elaborate adder structures need two or more clock cycles for this. If a multiplication result m0, ma should be available in each clock cycle, but if nevertheless a few clock cycles are permissible between the input and output, so to speak as running time, then the above-mentioned pipeline process is also suitable for the adder.

The restriction of the number range for the coefficients and thus the reduction of the required place shift processes will now be explained in terms of some examples. The number four (4) is defined as a binary number with a single value 2², and thus requires only a single binary place, namely 2². The other places 2¹ and 2⁰ have the value zero. This corresponds to a single shift process for the number being multiplied, namely by two places. A counterexample is the number fifteen (15) which, as a usual binary number requires four binary places and is represented as “1111”, namely 2³+2²+2¹+2⁰. This requires four independent shift processes for the number being multiplied, with subsequent addition of like places. In the canonical notation, however, the number fifteen requires only two binary places, namely 2⁴−2⁰. This corresponds to only two shift processes, one by four places and a second by zero places, with the latter value being subtracted, through its negative sign, from the first shift result. Another numerical example, which corresponds to the usual range of values from 0 to 1 or from −1 to +1 in signal processors, is the value 0.234375=(2⁻²−2⁻⁶). Multiplication of this numerical value by the number “a” then has the simple solution (a2⁻²−a2⁻⁶), that is again two shift processes by two places and by six places in a direction of lower place values, then the negation of one value, and subsequent addition of the results of the two shift processes. The resulting summation of the shifted values represents the product of the multiplication.

The computing device of the present invention is not limited to digital filters. It is contemplated that the computing device may also be used for other applications including for example linear amplification or reduction of signals, if a simple place shift is too coarse.

All values that can be represented in this relatively simple manner form a number inventory for the possible coefficients. The appropriate coefficients for a particular application are found through a simulation and optimization process. The effort expended for this does not matter because once the coefficients have been specified, these values no longer need to be changed and can be stored in a memory. Whether filter coefficients or other values are involved is irrelevant to the invention. Whether the individual functions, such as place shifts, negation, and addition, run within a single clock cycle as complete function executions or time-staggered in a pipeline process extending at least over two clock cycles, is of subordinate importance. It must only be assured that all the required commands are always available at the proper time. As a rule, the required commands or instructions are thus coded in a single command word.

Although the present invention has been shown and described with respect to several preferred embodiments thereof, various changes, omissions and additions to the form and detail thereof, may be made therein, without departing from the spirit and scope of the invention.

What is claimed is:

1. A computing device on a monolithic integrated circuit for multiplying together a digitized multiplier signal value and a digitized multiplicant signal value, said computing device comprising:
an input interface that receives said multiplicant and provides a received multiplicant indicative thereof;
a first place shifting device that includes a first logical assignment circuit to shift data bits of said received multiplicant in response to a first shift command signal, and provides a first shifted signal indicative thereof;
a second place shifting device that includes a second logical assignment circuit to shift data bits of said received multiplicant in response to a second shift command signal, and provides a second shifted signal indicative thereof;
means for summing said first and second shifted signals to provide a summed signal value that is indicative of the product of said multiplier and said multiplicant; and
a control device that receives a signal indicative of said multiplier, and generates said first and second shift command signals indicative of said multiplier value.

2. The computing device of claim 1, comprising a memory device for storing said summed signal, and for providing past values of said summed signal value.

3. The computing device of claim 2, wherein said means for summing receives and sums a signal value from said memory device indicative of a past value of said summed signal value with said first and second shifted signals to provide said summed signal value.

4. The computing device of claim 1, wherein said first place shifting device comprises a first sign inverter that receives and inverts the sign of said received multiplicant to provide a sign inverted received multiplicant signal that is input to said first logical assignment circuit for bit shifting.

5. The computing device of claim 4, wherein said second place shifting device comprises a second sign inverter that receives and selectively inverts the sign of said received multiplicant to provide a second sign inverted received multiplicant signal that is input to said second logical assignment circuit for bit shifting.

6. The computing device of claim 1, wherein said control unit generates a first sign inversion command signal in response to said multiplier value, wherein said first sign inversion signal is input to said first sign inverter to selectively enable the sign inversion.

7. A computing device on a monolithic integrated circuit for multiplying together a digitized multiplier signal value and a digitized multiplicant signal value, said computing device comprising:
an input interface that receives said multiplicant and provides a received multiplicant indicative thereof;
first means for shifting data bits of said received multiplicant in response to a first shift command signal, and for providing a first shifted signal indicative thereof;
second means for shifting data bits of said received multiplicant in response to a second shift command signal, and for providing a second shifted signal indicative thereof;
means for summing said first and second shifted signals to provide a summed signal value that is indicative of the product of said multiplier and said multiplicant; and
a control device that receives a signal indicative of said multiplier that is a binary coded number using canonical form, and generates said first and second shift command signals indicative of said multiplier value.

8. The computing device of claim 7, comprising a memory device for storing said summed signal, and for providing past values of said summed signal value.

9. The computing device of claim 8, wherein said means for summing receives and sums a signal value from said memory device indicative of a past value of said summed signal value with said first and second shifted signals to provide said summed signal value.

10. The computing device of claim 7, wherein said first means for shifting comprises a first sign inverter that receives and inverts the sign of said received multiplicant to provide a sign inverted received multiplicant signal that is input to said first logical assignment circuit for bit shifting.

11. The computing device of claim 10, wherein said second means for shifting comprises a second sign inverter that receives and selectively inverts the sign of said received multiplicant to provide a second sign inverted received multiplicant signal that is input to said second logical assignment circuit for bit shifting.

12. A computer unit for a first (z) and a second (k, k*) number comprising:
at least one place shifting device (3, 4), whose shift position is controlled by an associated shift instruction (s1, s2) in dependence on the second number (k, k*), and to whose position inputs are conducted the value-ordered places of the first number (z), which generally is a binary coded dual number;
the input or output of each place shifting device (s1, s2) has associated with it a sign inverter (5, 6), which is controlled by an associated sign instruction (n1, n2), in dependence on the second number (k, k*), which generally is a binary coded dual number using the canonical form;
on the output side, each place of the place shifting device (3, 4) is connected respectively to a place input of a four-place adder (7); and
the functions such as place shifting, negation, and addition run as completed function executions within a single clock cycle or time-staggered in a pipeline process extending over at least two clock cycles.

13. The computing unit of claim 12, wherein the number of place shifting devices (3, 4) that can be controlled independently of one another depends on the choice of the second number (k, k*), mainly on the maximum number of places of the second number (k, k*), which is determined by this choice, the places with the value zero being excluded from the considered set of places.

14. The computing unit of claim 12, wherein in the shift instruction (s1, s2) for the particular place shifting device (3, 4), a shift position is also defined for which the outputs for the following adder (7) are blocked or are set to zero.

15. The computer unit of claim 14, wherein the output places of the adder (7) are coupled to the inputs of a summation memory (8).

16. The computer unit of claim 15, wherein a summation instruction (ak) activates a data path that correctly feeds back the place outputs of the summation memory (8) to the adding inputs of the adder (7).

17. The computer unit of claim 16, wherein the first number (z) and the second number (k, k*) are binary coded dual numbers, and that the first and second number (z and k, k*), are multiplied by successive shift processes of a single place shifting device (3), the particular shift positions being determined by successive shift instructions (s1), in dependence on the values of the associated binary places of the second number (k, k*).

18. The computer unit of claim 17, wherein if two or more place shifting devices (3, 4) are present, the successive shift processes take place by groups, in that a binary position of the second number (k, k*) is associated with each place shifting device (3, 4), the associated binary positions of the second number being determined by successive shift instructions (s1, s2).
